(19) United States
(12) Patent Application Publication
(10) Pub. No.: US 2012/0104995 A1
(43) Pub. Date: May 3, 2012

(54) CHARGING DEVICE FOR MOBILE TERMINAL

(75) Inventors: Sang Sung WOO, Seoul (KR); Bum Ho CHUN, Seoul (KR); Eun Uae LEE, Seoul (KR)

(73) Assignee: SAMSUNG ELECTRONICS CO. LTD., Suwon-si (KR)

(21) Appl. No.: 13/272,593

(22) Filed: Oct. 13, 2011

(30) Foreign Application Priority Data
Oct. 28, 2010 (KR) 10-2010-0106041

(51) Int. Cl. H02J 7/00

(52) U.S. Cl. 320/107

(57) ABSTRACT

A charging device for a mobile terminal is provided. The charging device includes a charging unit for sustaining a posture of the mobile terminal when the mobile terminal is connected to the charging device and for charging the mobile terminal by electrically connecting to the mobile terminal, and a stand, detachably mounted to the charging unit and protruded from the charging unit to be interposed between the charging unit and the ground, for sustaining a posture of the mobile terminal by supporting the mobile terminal separately from the charging unit when the stand is detached from the charging unit, wherein the stand includes a stand groove for fixing the mobile terminal by housing at least a portion of the mobile terminal. Therefore, the charging device performs a stand function as well as a charging function for the mobile terminal, thereby providing more improved use efficiency.

### PRIORITY

This application claims the benefit under 35 U.S.C. §119(a) of a Korean patent application filed on Oct. 28, 2010 in the Korean Intellectual Property Office and assigned Serial No. 10-2010-0106041, the entire disclosure of which is hereby incorporated by reference.

### BACKGROUND OF THE INVENTION

1. Field of the Invention

The present invention relates to a charging device for a mobile terminal. More particularly, the present invention relates to a charging device for a mobile terminal that can perform a plurality of functions.

2. Description of the Related Art

As various functions are added to a mobile terminal, the mobile terminal becomes more complex. Recent mobile terminals provide various functions, such as an audio communication function, an audiovisual communication function, a wireless Internet function, a Moving Picture Experts Group (MPEG)-1 or MPEG-2 audio layer-3 (MP3) player function, and a digital broadcasting function. The mobile terminal is driven using power from an internal battery. In order to charge the battery, the mobile terminal is electrically connected to a separate charging device. The charging device charges the battery of the mobile terminal.

However, when using the mobile terminal, a user of the mobile terminal may not be able to charge the battery. The user of the mobile terminal may need to position the mobile terminal in a manner appropriate for a function currently being performed by the mobile terminal. For example, when viewing digital broadcasting through the mobile terminal, the user of the mobile terminal should arrange the mobile terminal in a position suitable for viewing the content on the mobile terminal, which may be difficult when the mobile terminal is connected to a charging device for charging. As a result, convenience of the user of the mobile terminal is deteriorated.

### SUMMARY OF THE INVENTION

Aspects of the present invention are to address at least the above-mentioned problems and/or disadvantages and to provide at least the advantages described below. Accordingly, an aspect of the present invention is to provide a charging device for a mobile terminal that can improve convenience of a user of the mobile terminal by sustaining a posture of the mobile terminal using the charging device.

In accordance with an aspect of the present invention, a charging device for a mobile terminal is provided. The charging device includes a charging unit for sustaining a posture of the mobile terminal when the mobile terminal is connected to the charging device and for charging the mobile terminal by electrically connecting to the mobile terminal, and a stand, detachably coupled to the charging unit and protruded from the charging unit to be interposed between the charging unit and the ground, for sustaining a posture of the mobile terminal by supporting the mobile terminal separately from the charging unit when the stand is detached from the charging unit, wherein the stand includes a stand groove for fixing the mobile terminal by housing at least a portion of the mobile terminal.

In accordance with another aspect of the present invention, a stand for a mobile terminal is provided. The stand includes a stand groove for fixing a mobile terminal by housing at least a portion of the mobile terminal, wherein the stand is connectable to a charging unit such that, when the stand is connected to the charging unit, the stand protrudes from the charging unit, and wherein the stand sustains a posture of the mobile terminal by supporting the mobile terminal separately from the charging unit when the stand is not connected to the charging unit.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B are perspective views illustrating a charging device according to a first exemplary embodiment of the present invention;

FIGS. 2A and 2B are perspective views illustrating a use example of the charging device of FIGS. 1A and 1B according to an exemplary embodiment of the present invention;

FIGS. 3A and 3B are perspective views illustrating a charging device according to a second exemplary embodiment of the present invention;

FIGS. 4A and 4B are perspective views illustrating a use example of the charging device of FIGS. 3A and 3B according to an exemplary embodiment of the present invention;

FIGS. 5A and 5B are perspective views illustrating a charging device according to a third exemplary embodiment of the present invention; and

FIGS. 6A and 6B are perspective views illustrating a use example of the charging device of FIGS. 5A and 5B according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

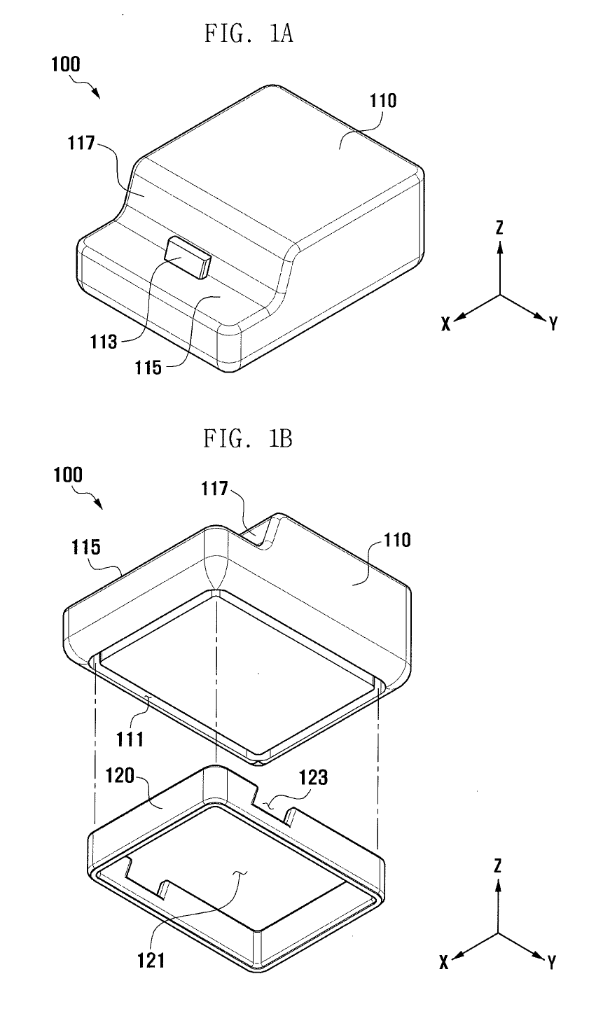

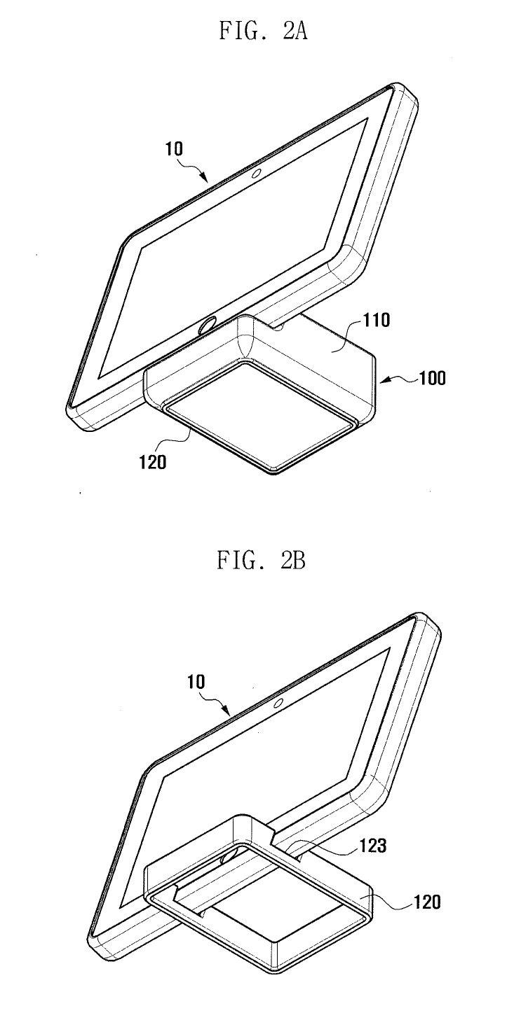

FIGS. 1A and 1B are perspective views illustrating a charging device according to a first exemplary embodiment of the present invention. FIG. 1A is a coupled perspective view illustrating the charging device according to the first exemplary embodiment of the present invention, and FIG. 1B is an exploded perspective view illustrating the charging device according to the first exemplary embodiment of the present invention. FIGS. 2A and 2B are a perspective view illustrating a use example of the charging device of FIGS. 1A and 1B according to an exemplary embodiment of the present invention.

Referring to FIGS. 1A and 1B, a charging device 100 includes a charging unit 110 and a stand 120.

The charging unit 110 performs a charging function and a stand function of a mobile terminal 10. The charging unit 110 has a predetermined thickness. The charging unit 110 has an insertion groove 111 in an upward direction, for example a Z-axis direction, from a lower surface disposed most adjacent to the ground in the charging unit 110. The insertion groove 111 has a predetermined depth at the inside of the charging unit 110 in an upward direction, for example a Z-axis direction from a lower surface of the charging unit 110. The insertion groove 111 may be inclined by a predetermined angle from the ground, for example, a plane formed by an X-axis and a Y-axis in the charging unit 110. The insertion groove 111 has a depth less than a thickness of the charging unit 110. The insertion groove 111 has a predetermined shape with a predetermined width in a horizontal direction, for example an X-axis or Y-axis direction at the inside of the charging unit 110.

The charging unit 110 has a charging circuit (not shown) and a charging terminal 113 for charging the mobile terminal 10. The charging circuit is provided within the charging unit 110. The charging circuit is connected to an external power source (not shown) through one end portion. The charging terminal 113 is connected to the other end portion of the charging circuit and at least a portion thereof is exposed (or protruded) to the outside. The charging terminal 113 is electrically connected to the mobile terminal 10. The charging terminal 113 is inserted into the mobile terminal 10 to be electrically connected to the mobile terminal 10.

The charging unit 110 includes a support 115 and a posture support 117 for supporting the mobile terminal 10. The support 115 supports the mobile terminal 10 by contacting with at least a portion of the mobile terminal 10. The support 115 supports the mobile terminal 10 in a vertical direction, for example a Z-axis direction from the ground. The support 115 is formed in a plane parallel to the ground. The support 115 exposes the charging terminal 113 to the outside. The posture support 117 supports the mobile terminal 10 to have a predetermined posture by contacting with at least a portion of the mobile terminal 10. The posture support 117 is extended from the support 115 to support the mobile terminal 10 together with the support 115. The posture support 117 supports the mobile terminal 10 in a vertical direction and a horizontal direction, for example X-axis, Y-axis, and Z-axis directions from the ground. The posture support 117 is formed in a plane inclined by a predetermined angle from the ground.

Referring to FIG. 2A, when the mobile terminal 10 is connected to the charging device 100, the charging unit 110 sustains a posture of the mobile terminal 10 in a state inclined by a predetermined angle from the ground to correspond to the posture support 117. The charging unit 110 supplies power from an external power source to the mobile terminal 10 through the charging circuit and the charging terminal 113 by electrically connecting to the mobile terminal 10. The charging terminal 113 is protruded from the support 115 to the outside in an angle similar to an angle in which the posture support 117 is inclined from the ground. The charging terminal 113 protruded to the outside is inserted into the mobile terminal 10 to fix a posture of the mobile terminal 10 to the charging unit 110.

The stand 120 performs a movement prevention function of the charging unit 110 and a stand function of the mobile terminal 10. The stand 120 is detachably attached to the charging unit 110. The stand 120 is mounted in the charging unit 110 or separated from the charging unit 110 through the insertion groove 111. The stand 120 has a shape corresponding to the insertion groove 111.

The stand 120 is formed in a frame structure for coupling to the charging unit 110. In order to be inserted into the insertion groove 111 of the charging unit 110, the stand 120 is formed in a structure having a coupling hole 121 in a central portion. As shown in FIG. 2A, when the stand 120 is inserted into the insertion groove 111, the stand 120 is coupled to the charging unit 110 through the coupling hole 121. The stand 120 has a predetermined height. The stand 120 has a height exceeding a depth of the insertion groove 111. When the stand 120 is inserted into the insertion groove 111, a portion of the stand 120 is protruded from the insertion groove 111 to the outside based on a lower surface of the charging unit 110. When the stand 120 is mounted in the charging unit 110, the stand 120 is interposed between the charging unit 110 and the ground. Accordingly, the stand 120 protects the charging unit 110 or the ground by preventing movement, i.e., sliding of the charging unit 110. For this purpose, the stand 120 may be formed with, for example, a rubber material.

The stand 120 is formed in a structure having a stand groove 123 for supporting the mobile terminal 10 separately from the charging unit 110. The stand groove 123 may be extended in a vertical direction, for example a Z-axis direction to correspond to the ground in the stand 120 or may be extended in an opposite direction thereof.

Referring to FIG. 2B, the stand 120 houses the mobile terminal 10 through the stand groove 123 and contacts with at least a portion of the mobile terminal 10. When the mobile terminal 10 is connected to the charging device 100, the stand 120 fixes the mobile terminal 10 through the stand groove 123. The stand 120 sustains a posture of the mobile terminal 10 to be inclined by a predetermined angle from the ground. The stand groove 123 may be formed to sustain a posture of the mobile terminal 10 in the same angle as an angle in which the posture support 117 is inclined from the ground, or may be formed to sustain a posture of the mobile terminal 10 in an angle different from an angle in which the posture support 117 is inclined from the ground. When the stand 120 is separated from the charging unit 110, the stand 120 may be used separately from the charging unit 110. In order to house the mobile terminal 10 in the stand 120 through the stand groove 123, the stand 120 rotates and is used in a forming direction of the stand groove 123, for example about an X-axis or an Y-axis.

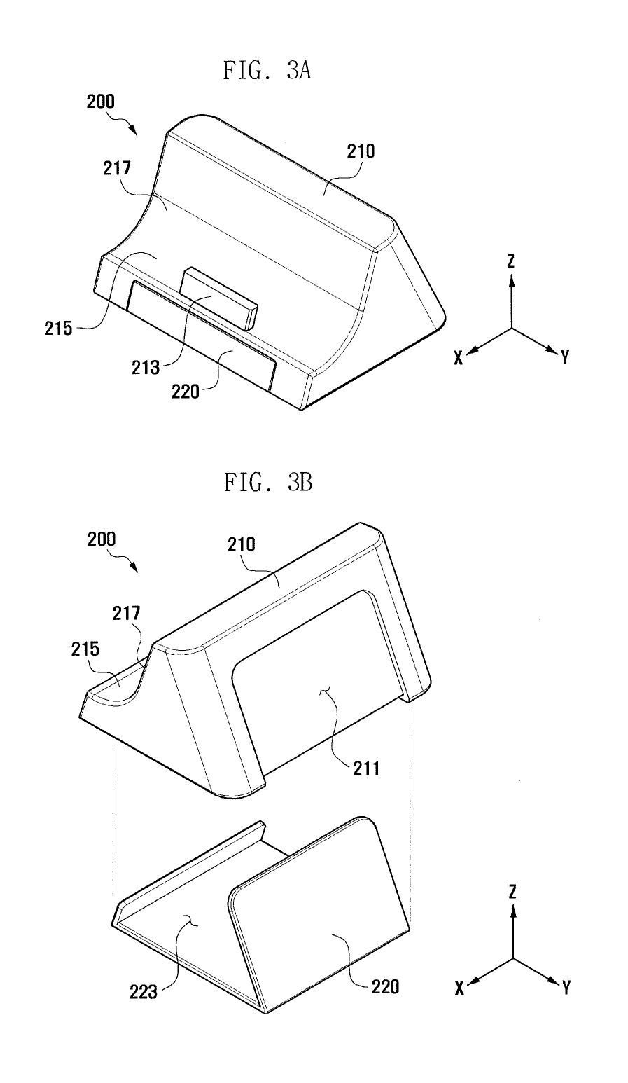

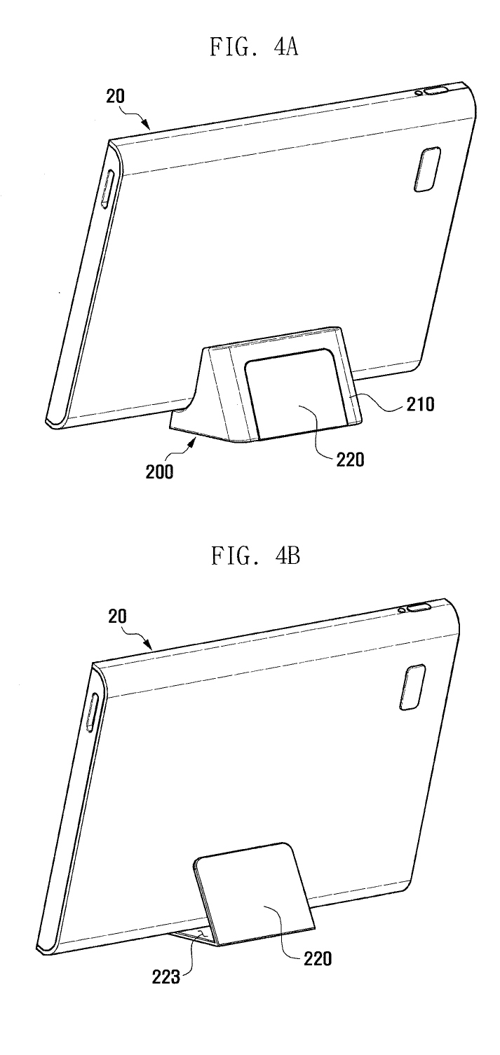

FIGS. 3A and 3B are perspective views illustrating a charging device according to a second exemplary embodiment of the present invention. FIG. 3A is a coupled perspective view illustrating the charging device according to the second exemplary embodiment of the present invention, and FIG. 3B is an exploded perspective view illustrating the charging device according to the second exemplary embodiment of the present invention. FIGS. 4A and 4B are a perspective view illustrating a use example of the charging device of FIGS. 3A and 3B according to an exemplary embodiment of the present invention.

Referring to FIGS. 3A and 3B, a charging device 200 includes a charging unit 210 and a stand 220.

The charging unit 210 performs a charging function and a stand function of a mobile terminal 20. The charging unit 210 has a predetermined thickness. The charging unit 210 has an insertion groove 211 in an upward direction, for example a Z-axis direction from a lower surface disposed most adjacent to the ground in the charging unit 210. The insertion groove 211 has a predetermined depth at the inside of the charging unit 210 in an upward direction, for example a Z-axis direction from a lower surface of the charging unit 210. The insertion groove 211 has a predetermined depth at the inside of the charging unit 210 from at least one side surface extended from a lower surface of the charging unit 210. The insertion groove 211 is formed to be inclined by a predetermined angle from the ground, for example a plane formed by an X-axis and a Y-axis in the charging unit 210. The insertion groove 211 has a depth less than a thickness of the charging unit 210.

The charging unit 210 includes a charging circuit (not shown) and a charging terminal 213 for charging the mobile terminal 20. The charging circuit is provided within the charging unit 210. The charging circuit is connected to an external power source (not shown) through one end portion. The charging terminal 213 is connected to the other end portion of the charging circuit, and at least a portion thereof is exposed (or protruded) to the outside. The charging terminal 213 is electrically connected to the mobile terminal 20. The charging terminal 213 is inserted into the mobile terminal 20 to be electrically connected to the mobile terminal 20.

The charging unit 210 includes a support 215 and a posture support 217 for supporting the mobile terminal 20. The support 215 supports the mobile terminal 20 by contacting with at least a portion of the mobile terminal 20. The support 215 supports the mobile terminal 20 in a vertical direction, for example a Z-axis direction from the ground. The support 215 is formed in a plane parallel to the ground. The support 215 exposes the charging terminal 213 to the outside. The posture support 217 supports the mobile terminal 20 to have a predetermined posture by contacting with at least a portion of the mobile terminal 20. The posture support 217 is extended from the support 215 to support the mobile terminal 20 together with the support 215. The posture support 217 supports the mobile terminal 20 in a vertical direction and a horizontal direction, for example X-axis, Y-axis, and Z-axis directions from the ground. The posture support 217 is formed in a plane inclined in a predetermined angle from the ground.

Referring to FIG. 4A, when the mobile terminal 20 is connected to the charging device 100, the charging unit 210 sustains a posture of the mobile terminal 20 in a state inclined by a predetermined angle from the ground to correspond to the posture support 217. The charging unit 210 supplies power from an external power source to the mobile terminal 20 through the charging circuit and the charging terminal 213 by electrically connecting to the mobile terminal 20. The charging terminal 213 is protruded from the support 215 to the outside in an angle similar to an angle in which the posture support 217 is inclined from the ground. The charging terminal 213 protruded to the outside fixes a posture of the mobile terminal 20 to the charging unit 210.

The stand 220 performs a movement prevention function of the charging unit 210 and a stand function of the mobile terminal 20. The stand 220 may be detachably attached to the charging unit 210. The stand 220 may be mounted in the charging unit 210 or separated from the charging unit 210 through the insertion groove 211. The stand 220 may have a shape corresponding to the insertion groove 211. Accordingly, the stand 220 is mounted in the charging unit 210 or is separated from the charging unit 210 in a circumferential area of the charging unit 210. The stand 220 is formed in a loop structure for coupling to the charging unit 210. The stand 220 is formed in a structure having a stand groove 223 for inserting the charging unit 210 to be fastened to a circumferential area of the charging unit 210 and for supporting the mobile terminal 20 separately from the charging unit 210. The stand groove 223 is extended in a downward direction, for example a Z-axis direction from an upper surface in the stand 220.

Referring to FIG. 4A, when the stand 220 is inserted into the insertion groove 211, the stand 220 is coupled to the charging unit 210 through the stand groove 223. The stand 220 has a predetermined height. The stand 220 has a height exceeding a depth of the insertion groove 211. When the stand 220 is inserted into the insertion groove 211, a portion of the stand 220 is protruded to the outside from the insertion groove 211 based on a lower surface of the charging unit 210. When the stand 220 is mounted in the charging unit 210, the stand 220 is interposed between the charging unit 210 and the ground. Accordingly, the stand 220 protects the charging unit 210 or the ground by preventing movement, i.e. sliding of the charging unit 210. For this, the stand 220 may be formed with a rubber material.

Referring to FIG. 4B, the stand 220 houses the mobile terminal 20 through the stand groove 223 and contacts with at least a portion of the mobile terminal 20. When the mobile terminal 20 is connected to the charging device 100, the stand 220 fixes the mobile terminal 20 through the stand groove 223. The stand 220 sustains a posture of the mobile terminal 20 to be inclined by a predetermined angle from the ground. The stand groove 223 may be formed to sustain a posture of the mobile terminal 20 in the same angle as an angle in which the posture support 217 is inclined from the ground, or may be formed to sustain a posture of the mobile terminal 20 in an angle different from an angle in which the posture support 217 is inclined from the ground. When the stand 220 is separated from the charging unit 210, the stand 220 may be used separately from the charging unit 210.

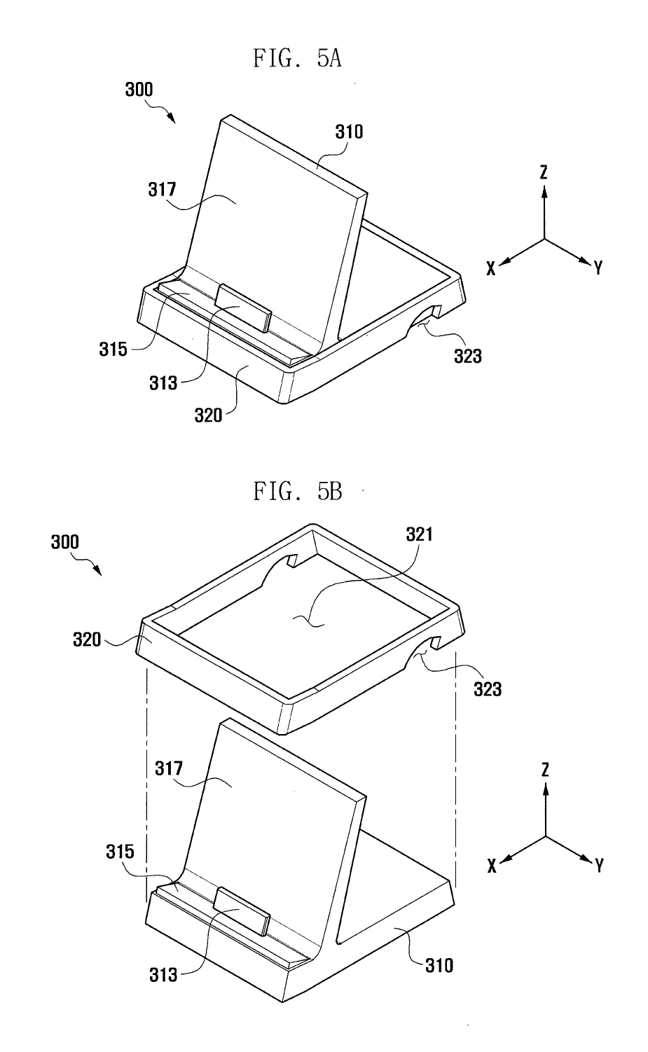

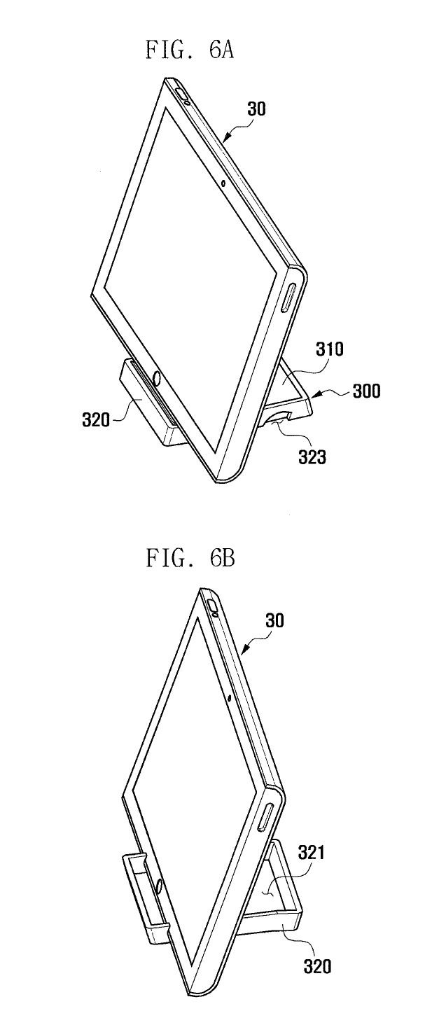

FIGS. 5A and 5B are perspective views illustrating a charging device according to a third exemplary embodiment of the present invention. FIG. 5A is a coupled perspective view illustrating the charging device according to the third exemplary embodiment of the present invention, and FIG. 5B is an exploded perspective view illustrating the charging device according to the third exemplary embodiment of the present invention. FIGS. 6A and 6B are a perspective views illustrating a use example of the charging device of FIGS. 5A and 5B according to an exemplary embodiment of the present invention.

Referring to FIGS. 5A and 5B, a charging device 300 includes a charging unit 310 and a stand 320.

The charging unit 310 performs a charging function and a stand function of a mobile terminal 30. The charging unit 310 has a predetermined thickness. An area of an upper surface of the charging unit 310 may be greater or smaller than that of a lower surface.

The charging unit 310 includes a charging circuit (not shown) and a charge terminal 313 for charging the mobile terminal 30. The charging circuit is provided within the charging unit 310. The charging circuit is connected to an external power source (not shown) through one end portion. The charging terminal 313 is connected to the other end portion of the charging circuit, and at least a portion thereof is exposed (or protruded) to the outside. The charging terminal 313 is electrically connected to the mobile terminal 30. The charging terminal 313 is inserted into the mobile terminal 30 to be electrically connected to the mobile terminal 30.

The charging unit 310 includes a support 315 and a posture support 317 for supporting the mobile terminal 30. The support 315 supports the mobile terminal 30 by contacting with at least a portion of the mobile terminal 30. The support 315 supports the mobile terminal 30 in a vertical direction, for example a Z-axis direction from the ground. The support 315 is formed in a plane parallel to the ground. The support 315 exposes the charging terminal 313 to the outside. The posture support 317 supports the mobile terminal 30 to have a predetermined posture by contacting with at least a portion of the mobile terminal 30. The posture support 317 is extended from the support 315 to support the mobile terminal 30 together with the support 315. The posture support 317 supports the mobile terminal 30 in a vertical direction and a horizontal direction, for example X-axis, Y-axis, and Z-axis directions from the ground. The posture support 317 is formed in a plane inclined by a predetermined angle from the ground.

Referring to FIG. 6A, when the mobile terminal 30 is connected to the charging device 300, the charging unit 310 sustains a posture of the mobile terminal 30 in a state inclined by a predetermined angle from the ground to correspond to the posture support 317. The charging unit 310 supplies power from an external power source to the mobile terminal 30 through the charging circuit and the charging terminal 313 by electrically connecting to the mobile terminal 30. The charging terminal 313 is protruded from the support 315 to the outside in an angle similar to an angle in which the posture support 317 is inclined from the ground. The charging terminal 313 protruded to the outside fixes a posture of the mobile terminal 30 to the charging unit 310.

The stand 320 performs a movement prevention function of the charging unit 310 and a stand function of the mobile terminal 30. The stand 320 may be detachably attached to the charging unit 310. The stand 320 may be mounted in the charging unit 310 or separated from the charging unit 310 in a circumferential area of the charging unit 310. The stand 320 may be mounted in the charging unit 310 or separated from the charging unit 310 in a vertical direction, i.e. in a Z-axis direction from the ground. For example, the stand 320 may be mounted or separated in a downward direction from an upper surface of the charging unit 310, and the stand 320 may be mounted or separated in an upward direction from a lower surface of the charging unit 310.

The stand 320 is formed in a frame structure for coupling to the charging unit 310. In order to insert the charging unit 310, the stand 320 is formed in a structure having a coupling hole 321 in a central portion. The coupling hole 321 is formed in a shape corresponding to a side surface connecting an upper surface and a lower surface of the charging unit 310. As shown in FIG. 6A, when the stand 320 is inserted into the charging unit 310 through the coupling hole 321, the stand 320 is coupled to the charging unit 310 through the coupling hole 321. When the stand 320 is mounted in the charging unit 310, a portion of the stand 320 is protruded to the outside based on a lower surface of the charging unit 310. When the stand 320 is mounted in the charging unit 310, the stand 320 is interposed between the charging unit 310 and the ground. Accordingly, the stand 320 protects the charging unit 310 or the ground by preventing movement, i.e. sliding of the charging unit 310. For this purpose, the stand 320 may be formed with a rubber material.

The stand 320 is formed in a structure having a stand groove 323 for supporting the mobile terminal 30 separately from the charging unit 310. The stand groove 323 may be extended in a vertical direction, for example a Z-axis direction to correspond to the ground in the stand 320 or may be extended in an opposite direction thereof.

Referring to FIG. 6B, the stand 320 houses the mobile terminal 30 through the stand groove 323 and contacts with at least a portion of the mobile terminal 30. When the mobile terminal 30 is connected to the charging device 300, the stand 320 fixes the mobile terminal 30 through the stand groove 323. The stand 320 sustains a posture of the mobile terminal 30 to be inclined by a predetermined angle from the ground. The stand groove 323 may be formed to sustain a posture of the mobile terminal 30 in the same angle as an angle in which the posture support 317 is inclined from the ground, or may be formed to sustain a posture of the mobile terminal 30 in an angle different from an angle in which the posture support 317 is inclined from the ground. When the stand 320 is separated from the charging unit 310, the stand 320 may be used separately from the charging unit 310. In order to house the mobile terminal 30 in the stand 320 through the stand groove 323, the stand 320 rotates and is used in an extension direction of the stand groove 323, for example about an X-axis or an Y-axis.

According to exemplary embodiments of the present invention, a charging device for a mobile terminal performs a stand function as well as a charging function, thereby providing more improved use efficiency. The charging device charges and supports the mobile terminal through the charging unit. The charging device supports the mobile terminal through the stand separately from the charging unit. The charging device provides more improved mobility through the stand, thereby providing user convenience.

As described above, according to exemplary embodiments of the present invention, a charging device for a mobile terminal performs a stand function as well as a charging function, thereby providing more improved use efficiency. The charging device supports a mobile terminal while charging the mobile terminal through a charging unit. The charging device supports the mobile terminal separately from the charging unit through a stand. The charging device provides more improved mobility through the stand and improves convenience of a user of the mobile terminal.

While the invention has been shown and described with reference to certain exemplary embodiments thereof, it will be by those skilled in the art that various changes in form and details may be made therein without departing from the spirit and scope of the invention as defined by the appended claims and their equivalents.

What is claimed is:

1. A charging device for a mobile terminal, the charging device comprising:
a charging unit for sustaining a posture of the mobile terminal when the mobile terminal is connected to the charging device, and for charging the mobile terminal by electrically connecting to the mobile terminal; and
a stand, detachably coupled to the charging unit and protruded from the charging unit to be interposed between the charging unit and the ground, for sustaining a posture of the mobile terminal by supporting the mobile terminal separately from the charging unit when the stand is detached from the charging unit,
wherein the stand includes a stand groove for fixing the mobile terminal by housing at least a portion of the mobile terminal.

2. The charging device of claim 1, wherein the charging unit comprises an insertion groove for inserting the stand in a vertical direction from a lower surface.

3. The charging device of claim 2, wherein the insertion groove is extended along at least one side surface from the lower surface of the charging unit.

4. The charging device of claim 1, wherein the stand is formed in a frame structure having a coupling hole for housing the charging unit in a central portion and for coupling to the charging unit.

5. The charging device of claim 1, wherein the stand groove sustains the mobile terminal to be inclined by a predetermined angle from the ground when the mobile terminal is connected to the charging device.

6. The charging device of claim 1, wherein the charging unit comprises an exposed charge terminal for electrically connecting the mobile terminal when the mobile terminal is connected to the charging device.
